(19) United States
(12) Patent Application Publication
(10) Pub. No.: US 2026/0016374 A1
(43) Pub. Date: Jan. 15, 2026

(54) System and Method for Executing a Power-On-Self-Test (POST) on Conveyor Systems and Sortation Equipment

(71) Applicant: Tenivus, Inc., Lowell, MI (US)

(72) Inventors: Philipp Varley, Ada, MI (US); James W. Clum, Belding, MI (US); Timm G. Mittlestat, Lowell, MI (US); Christopher F. Pylman, Byron Center, MI (US)

(21) Appl. No.: 18/767,823

(22) Filed: Jul. 9, 2024

(51) Int. Cl. G01M 99/00

(52) U.S. Cl. CPC G01M 99/005

(57) ABSTRACT

The present invention provides a novel system and method for executing a Power-On-Self-Test (POST) at the controls level of PLCs for conveyor systems and sortation equipment. By utilizing dynamic physical motions and various sensor inputs, the system effectively measures and analyzes the health status of the equipment, enabling timely maintenance actions to prevent unexpected failures and ensure operational efficiency.

### BACKGROUND OF THE INVENTION

Conveyor systems and sortation equipment are integral to automated material handling processes. Maintaining the operational efficiency and health of these systems is critical to avoid downtime and ensure smooth operations. Traditional maintenance methods often rely on alarms and warnings generated during equipment operation. However, these methods do not provide comprehensive insights into the dynamic processes and health status of the equipment, which can only be gathered during a controlled stimulus of the system. The Power-On-Self-Test (POST) used in electronics performs self-checks to ensure the functionality of components before operation. However, there is a need for a similar approach in conveyor systems and sortation equipment, where the health status of the system can be measured dynamically by executing physical motions and comparing various inputs to nominal values.

### SUMMARY OF THE INVENTION

The present invention provides a system and method for executing a Power-On-Self-Test (POST) at the controls level of PLCs for conveyor systems and sortation equipment. This system utilizes various inputs available to the PLC, such as vibration/frequency data, photoelectric inputs, power consumption, speed, encoder feedback, and other relevant data, to measure the health status of the system. The POST process involves executing defined physical motions to measure and compare dynamic inputs to nominal values, enabling the detection of defects or deviations that are not discernible during regular operation.

### FIELD OF THE INVENTION

The present invention relates generally to automated material handling systems. More specifically, it pertains to a system and method for executing a Power-On-Self-Test (POST) at the controls level of Programmable Logic Controllers (PLCs) used in conveyor systems and sortation equipment to aid in predictive, preventive, or corrective maintenance.

### DETAILED DESCRIPTION OF THE INVENTION

### System Architecture:

1. PLC Integration:
   i. The system is integrated with the existing PLCs controlling the conveyor systems and sortation equipment.
   ii. The PLCs are configured to execute the POST routine before, after, or between normal operation cycles.
2. Sensors and Inputs:
   i. The system uses various sensors and inputs available to the PLC, including but not limited to:
      1. Vibration and frequency sensors.
      2. Photoelectric sensors.
      3. Power consumption monitors.
      4. Speed and encoder data.
   ii. Additional sensors can be integrated to provide more comprehensive health status data.
3. POST Routine Execution:
   i. The POST routine involves executing a series of predefined physical motions of the conveyor system and sortation equipment.
   ii. During these motions, the system collects data from the sensors and inputs.
   iii. The collected data is compared to predefined nominal values to assess the health status of the equipment.
4. Data Analysis and Reporting:
   i. The system analyzes the collected data to identify any deviations from the nominal values.
   ii. Based on the analysis, the system generates reports indicating the health status of the equipment.
   iii. Predictive, preventive, or corrective maintenance actions are recommended based on the identified deviations.

### Operation:

1. Initiating the POST Routine:
   a. The POST routine can be initiated manually by an operator or automatically by the PLC based on a predefined schedule or trigger event.
   b. The routine is executed outside of normal production times to avoid interference with regular operations.
2. Data Collection and Comparison:
   a. The system executes the predefined physical motions and collects data from the sensors and inputs.
   b. The data is compared to the nominal values stored in the system's database to identify any anomalies.
3. Generating Maintenance Reports:
   a. The system generates reports listing any deviations and their potential impact on the equipment's performance.
   b. Maintenance recommendations are provided to address identified issues.
   c. Only alarms can be provided instead of a report.
4. Implementing Maintenance Actions:
   a. Based on the generated reports, maintenance personnel can perform the necessary predictive, preventive, or corrective actions to ensure the continued health of the conveyor system and sortation equipment.

### Advantages:

1. Provides a comprehensive assessment of the equipment's health status through dynamic testing.
2. Identifies defects and deviations that are not detectable during regular operation.
3. Enhances the effectiveness of predictive, preventive, and corrective maintenance strategies.
4. Reduces the risk of unexpected equipment failures and associated downtime.

1. A system for executing a Power-On-Self-Test (POST) on conveyor systems and sortation equipment, comprising:
a. A programmable logic controller (PLC) configured to control the operation of the conveyor system and sortation equipment;
b. A single or plurality of sensors providing inputs to the PLC, including vibration/frequency sensors, photoelectric sensors, power consumption monitors, and speed/encoder data;
c. A control module or script or code, integrated with the PLC or standalone, configured to execute a predefined POST routine involving physical motions of the equipment;
d. A data analysis module configured to compare the collected sensor data to predefined nominal values and identify deviations;
e. A reporting module or script or code configured to generate maintenance reports or warnings or alarms and recommend predictive, preventive, or corrective actions based on the identified deviations.

2. The system of claim 1, wherein the POST routine is executed before, after, or between normal operation cycles of the conveyor system and sortation equipment.

3. The system of claim 1, wherein the control module initiates the POST routine based on a predefined schedule or trigger event.

4. The system of claim 1, further comprising additional sensors integrated with the PLC to provide comprehensive health status data.

5. The system of claim 1, wherein the reporting module provides detailed reports highlighting deviations from nominal values and their potential impact on equipment performance.

6. The system of claim 1, wherein the data analysis module uses the collected data to identify predictive, preventive, or corrective maintenance actions to be performed on the equipment.
